(19) United States
(12) Patent Application Publication
(10) Pub. No.: US 2006/0128773 A1
(43) Pub. Date: Jun. 15, 2006

(54) Wood preservatives and waterproofing compositions and processes

(76) Inventor: Ronald Jones, Norcross, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/007,856

(22) Filed: Dec. 9, 2004

(51) Int. Cl. A01N 43/80; B32B 21/02; B32B 21/10

(52) U.S. Cl. 514/373; 428/292.4

(57) ABSTRACT

An alkyl dimethyl benzyl ammonium saccharinate is put into solution with a water soluble alcohol, such as ethanol, and subsequently mixed with water to form a aqueous solution for the treatment of wood to protect it from attacks by fungus, insects and other pests or to waterproof the wood. Preferably this saccharinate is applied by pressure to the wood after the cells of the wood have been evacuated in a vacuum. A process for making this saccharinate water soluble is disclosed which involves dissolving the saccharinate in a water soluble alcohol and then mixing the alcohol with water at about 150° F. This aqueous solution can then be used to treat wood. The alkyl dimethyl benzyl ammonium saccharinate can be put into solution with either a myristamine oxide or lauramine oxide and then mixed with alcohol or glycol. Boric acid can be added to the solution to prevent the corrosion of nails in any wood that is treated.

### BACKGROUND OF THE INVENTION

1. Field of the Invention

This invention relates to aqueous wood preservatives and waterproofing compositions containing an alkyl dimethyl benzyl ammonium saccharinate. These compositions prevent staining and decay by microorganisms and insects.

2. Background of the Invention

Chromated copper arsenate (CCA) is commonly employed as a wood preservative. The chromium oxidizes the wood and generates sites for fixing the copper and arsenic to the wood. Although copper is a highly effective wood preservative, some fungi are resistant to its biocidal activity. The arsenic serves to control fungi that are tolerant to copper and protect the wood against wood destroying insects.

In recent years, however, many concerns have been raised regarding contamination of the environment by chromium and arsenic. There is also increasing concern regarding disposal of wood treated with chromated copper arsenate and halides.

As a result, there is a need for wood preservatives which do not contain chromium, arsenic, or halides and are environmentally friendly, yet have similar wood preservative properties to chromated copper arsenate.

Various quaternary halide compounds have been used. Compounds, such as alkyl dimethyl benzyl ammonium chlorides, have been used as wood preservatives. Alkaline copper quaternary ammonium compounds (ACQ) have been developed as wood preservatives in recent years because of the environmental and safety concerns with CCA. The ACQ compounds have serious problems when used in wood preservation formulations. The first problem is that the ACQ compounds accelerate corrosion of metal fasteners. Secondly, they are extremely water soluble, and when in contact with soil the compounds leach into the soil rapidly which reduces their effectiveness as a wood preservative and presents environmental concerns. The chloride based quaternary ammonium compounds are extremely water soluble. These halide preservatives are damaging to the environment. It has also been found that the quaternary halide compounds corrode the treatment equipment as halide salts such as chloride salts are formed which corrode the treatment equipment as treating solutions that are used in the equipment are recycled over and over again in partial treatment.

Wood requires treatment with microbiocides to prevent staining and decay by microorganisms. By wood is meant lumber, timber, posts, wood coverings, wicker, millwork, joinery, wood products such as plywood, fiberboard, chipboard, waferboard, particleboard, and other wood products used in construction.

Freshly milled timber and wood for millwork/joinery are usually treated with preservatives by dipping and double vacuum treatments. Wood for use in ground and many above ground applications is usually treated with a preservative by pressure treatment. Preservatives can also be applied by brushing, spraying, soaking, and similar treatment methods.

It would be desirable to have a wood preservative and water treatment composition which is very soluble in water and could be applied by pressure treatment to wood, with the microbiocide becoming insoluble in the wood so that it stays there in the event the wood is exposed to water. If the microbiocide stays in place in the wood it would be an effective microbiocide.

### SUMMARY OF THE INVENTION

Applicant has discovered that the alkyl dimethyl benzyl ammonium saccharinates can be dissolved in alcohol and mixed with water at approximately 150° F. to form an aqueous solution which is a wood preservative and provides waterproofing properties. This aqueous composition can be applied to wood by pressure treatment. The alkyl dimethyl benzyl ammonium saccharinate compounds are very effective as microbiocides.

The alkyl group in the alkyl dimethyl benzyl ammonium saccharinate, may be branched or a straight chain. The alkyl group may be a mixture of alkyls with a different number of carbon groups. A preferred alkyl group is a mixture of a approximately 50 percent of alkyl groups C₁₄, 40 percent of C₁₂ and 10 percent of C₁₆.

The alkyl dimethyl benzyl ammonium saccharinate is dissolved in a water miscible alcohol, which are the lower alkyl alcohols. Ethyl alcohol is preferred, but isopropyl alcohol or methyl alcohol or a combination thereof may be used.

The alkyl dimethyl benzyl ammonium saccharinate can constitute from approximate 1 to 10 percent of the aqueous solution by weight. Preferably from 2 to 6 percent of the alkyl dimethyl benzyl ammonium saccharinate is used. The alkyl dimethyl benzyl ammonium saccharinate is mixed with the alcohol in an amount so that it goes into the solution in the alcohol. Preferably from 30 to 70 percent of the aqueous solution is alcohol. In any event sufficient alcohol needs to be used to dissolve the alkyl dimethyl benzyl ammonium saccharinate. It may be necessary to heat the mixture to approximately 150° F. to dissolve the saccharinate.

Preferably the alkyl dimethyl benzyl ammonium saccharinate is dissolved in a water soluble amine oxide, such as the myristamine oxide or lauramine oxide. This solvent should be present in an amount from 25 to 500 percent by weight of the saccharinate. After the saccharinate is dissolved in a water soluble amine oxide it can be mixed with an alcohol, such as ethanol or glycol, such as propylene glycol, or combination thereof. This solution can be diluted with water and applied to wood.

Another embodiment of the present invention is a method for preserving and waterproofing a wood substrate by contacting the composition with the wood substrate.

Yet another embodiment is an article comprising a wood substrate and the composition of the present invention.

This composition has high efficacy against fungi, including copper tolerant fungi such as brown rot and soft rot. Also, the composition is phase stable at high concentrations without the need for polyamines or other stabilizers known in the prior art. The alkyl dimethyl benzyl ammonium saccharinate in the composition may impart waterproofing properties. The composition of the present invention is typically free of ionic halides, in particular chlorides, and is environmentally friendly.

The wood can be treated by any method for treating wood to preserve it. Preferably the wood is first subjected to a vacuum to remove air from the wood cells and then treated under pressure with an aqueous solution containing alkyl dimethyl benzyl ammonium saccharinate. The wood is removed from the treatment chamber and washed with water removing excess preservative and dried in an oven to remove moisture. It can however be applied to the wood by simple pressure treatment.

Once the wood has been treated with the alkyl dimethyl benzyl ammonium saccharinate, the later compound does not leach out in any appreciable quantity because it is insoluble in water. This saccharinate is a biocide which preserves the wood from attack. The alkyl dimethyl benzyl ammonium saccharinates are superior to the alkyl dimethyl benzyl ammonium chlorides which leach from the wood in the presence of water which removes the preservative from the wood and also poses environmental hazards.

Since the preserved wood is frequently fastened with metal fasteners it is important that the preservative not corrode the metal fasteners. The alkyl dimethyl benzyl ammonium saccharinate compounds corrode both steel and galvanized nails to a great extent. It has been found that the addition of boric acid to this saccharinate compound greatly reduces the corrosion of nails. Surprisedly, the addition of boric acid to the alkyl dimethyl benzyl ammonium saccharinate compound reduces the corrosion of nails more than the addition of boric acid to the alkyl dimethyl benzyl ammonium chloride compound. In fact the addition of boric acid to the alkyl dimethyl benzyl ammonium saccharinate compound reduces the corrosion of both galvanized and steel nails to an acceptable level which is not the case with the addition of boric acid to an alkyl dimethyl benzyl ammonium chloride compound.

Other compounds such as wood preservative biocides, inorganic copper compounds, other types of quaternary compounds and any combinations thereof can be used.

### DETAILED DESCRIPTION OF THE PREFERRED EMBODIMENTS

The most cost effective method of treating wood to protect it from mold and other pests is by pressure treating with water. It would be desirable to be able to pressure treat wood with a preservative that is soluble in water but is insoluble when the wood is exposed to water after treatment. This would prevent the preservative from being leached from the wood which would reduce the preservation value of the preservative and also pose an environmental hazard.

Compounds that were tested because of their potential as a preservative are the alkyl dimethyl benzyl ammonium saccharinates which were found to be extremely effective preservatives.

In the treatment of wood in order to render it resistant to biological attack, it is a common practice to treat it with a fluid-borne treating chemical. While this treatment can be done by soaking or impregnating the wood material with the fluid-foreign treating chemical, the most common treatment is pressure treatment. One of the most widely used pressure treatment methods is the empty cell process, as defined in the Book of Standards published by the American Wood Preserves Association, where the cores of the wood are partially evacuated before impregnation in order to increase the fluid retained therein. There is also the empty cell process in which the preliminary step of evacuation is omitted.

The alkyl dimethyl benzyl ammonium saccharinate is a registered biocide. Alkyl dimethyl benzyl ammonium saccharinate inhibits the growth of bacteria, mold, mildew, and fungi and is suitable as a preservative for the preservation of wood. It has the following efficacy based upon minimum inhibitory concentration (MIC) values.

Minimum Inhibitory Concentration (MIC) Values

| | | CONCENTRATION |
|---|---|---|
| | ATCC # | (PPM) |
| BATERIA | | |
| ENTEROBACTER AEROGENES | 13048 | 10 |
| ESCHERICHIA | 11229 | 10 |
| LISTERIA MONOCYTOGENES | 35152 | 1 |
| PSEUDOMONAS AERUGINOSA | 15442 | 100 |
| SERRATIA MARCESANS | 13880 | 10 |
| STAPHOCOCCUS AUREUS | 6538 | 1 |
| METHICILLIAN-RESISTANT | 33593 | 0.5 |
| STAPHYLOCOCCUS AUREUS | | |
| FUNGI | | |
| ASPERGILLUIS FUMIGATUS | 16424 | 10 |
| CANDIDA ALBICANS | 10231 | 100 |

*The MIC value represents the lowest test substances concentration, which inhibits growth in all replicates.

Alkyl dimethyl benzyl ammonium saccharinate has the following use dilution values, based upon a ten minute contact time, against the following organisms.

ASSOCIATION OF OFFICIAL ANALYTICAL CHEMIST (AOAC)
USE-DILUTION VALUES**

| ORGANISM | ATCC # | CONCENTRATION (PPM) |
|---|---|---|
| PSEUDOMONAS | 15442 | 700 |
| AERUGINOSA | | |
| SALMONELLA | 10708 | 600 |
| CHOLERAESUIS | | |
| STAPHYLOCOCCUS | 6538 | 600 |
| AUREUS | | |

**TEN-MINUTE CONTACT TIME.

It has been found that an alkyl dimethyl benzyl ammonium saccharinate can be dissolved in a water soluble alcohol, such as ethanol. Once the saccharinate has been dissolved in the alcohol, the alcohol can be mixed with water to prepare the formulation. It may be necessary to heat the mixture to approximately 150° F. so the saccharinate becomes soluble in the mixture.

The alkyl dimethyl benzyl ammonium saccharinates used as wood preservatives in this invention have from 5 to 20 carbon atoms and preferably from 10 to 14 carbon atoms in on the alkyl group.

A mixture of alkyl groups with different length chains can be used. These chains can be branched or a straight chain. A preferred mixture of alkyl groups consists of approximately 50 percent alkyl groups with C₁₄, 40 percent C₁₂ and 10 percent C₁₆ carbon atoms.

The alkyl dimethyl benzyl ammonium saccharinate is mixed with a water miscible alcohol. These are lower alkanols such as ethyl alcohol, isopropyl alcohol, methyl alcohol or combinations thereof. After the sacchrinate has been mixed with the alcohol and a solution is formed, the solution can be diluted with water to form the formulation used to pressure treat the wood.

The alkyl dimethyl benzyl ammonium saccharinate can be used in the final formulation in an amount from about 1 to 10 percent by weight of final formulation and preferably from about 2 to 6 percent. Preferably, the lower alcohol is used in the composition in the range from about 30 to 70 percent of the weight of the final formulation.

It has been found that the alkyl dimethyl benzyl ammonium saccharinate can be dissolved in a water soluble amine oxide with a chain link of C14 or less. The preferred water soluble amine oxides are myristamine oxide and lauramine oxide. The alkyl dimethyl benzyl ammonium saccharinate is very difficult to put in an aqueous solution. It has been found that the myristamine oxide or lauramine oxide can be mixed with an alcohol, such as ethanol and the mixture heated from 100 to 130° F. The alkyl dimethyl benzyl ammonium saccharinate can be added to the solution and dissolved. The water soluble amine oxide, such as the myristamine oxide or the lauramine oxide, can be used in an amount preferably from 25 to 500 percent by weight of the saccharinate is used.

An alcohol of from 1 to 6 carbon atoms, such as ethanol, can be used in a ratio of 1 to 5 to the saccharinate by weight or a glycol, such as propylene glycol, can be used. The glycol can be used in combination with the alcohol.

The following chart illustrates various combinations of the alkyl dimethyl benzyl ammonium saccharinate with a myristamine oxide or lauramine oxide and alcohol and glycol that are preferred.

| | Sample A | Sample B | Sample C | Sample D | Sample E | Sample F |
|---|---|---|---|---|---|---|
| ADBAS* (QUAT) | 2.00 | 2.00 | 2.00 | 2.00 | 2.00 | 2.00 |
| ALCOHOL | 2.00 | 2.00 | 2.00 | 2.00 | 2.00 | 10.00 |
| AMMONYX LO | 0.5 | 1.0 | 1.5 | 2.0 | 5.0 | 2.00 |
| OR MO | | | | | | |
| GLYCOL | 0.00 | 0.00 | 10.00 | 0.00 | 0.00 | 0.00 |
| WATER | 95.5 | 95.0 | 84.5 | 94.0 | 91.0 | 86.0 |
| TEMPERATURE | 200° F. | 200° F. | 100° | 150° F. | AMBIENT | 100° F. |
| SOLUBLE | NO | NO | YES | YES | YES | YES |

*N-ALKYL DIMETHYL BENZYL AMMONIUM SACCHARINATE

A preferred formulation is the use of the alkyl dimethyl benzyl ammonium saccharinates to the myristamine oxide or the lauramine oxide in an amount where it is present as a percentage of the alkyl dimethyl benzyl ammonium saccharinates from about 25 to 250 percent by weight of the saccharinate. The alcohol, such as ethanol, or glycol, such as proplyene glycol, can be used in a percentage from 100 to 500 percent. by weight of the saccharinate. These weights are based upon the combination of the above ingredients without being diluted by water. The type and quantity of solvents used for the alkyl dimethyl benzyl ammonium saccharinates is also a factor of the temperature of the mixture. Less solvent is needed at higher temperatures. This composition is typically substantially free of ionic halides and preferably contains less than about 10 ppm (w/w) of ionic halides.

Other water miscible solvents including, but not limited to, ethers, such as ethyl ether; polyethers; amine; and any combination of the foregoing.

The concentrate formed above may be diluted with water so that it is consist of about 0.1 to 10 percent for treating wood.

Both the alkyl dimethyl benzyl ammonium saccharinates and alkyl dimethyl benzyl ammonium chlorides are corrosive to steel and galvanized steel. This is unacceptable because these preservatives are frequently used on decks and other structures which are held together by nails or screws. Tests were conducted by adding boric acid both to alkyl dimethyl benzyl ammonium saccharinate and to an alkyl dimethyl benzyl ammonium chloride. Unexpected results were obtained in that the boric acid greatly reduced the corrosion of the alkyl dimethyl benzyl ammonium saccharinate, which is greatly superior to the addition of boric acid to an alkyl dimethyl benzyl ammonium chloride. The addition of boric acid to the alkyl dimethyl benzyl ammonium saccharinate made the use of this saccharinate acceptable on wood that had either galvanized or steel fasteners. This combination was the only combination acceptable for use with steel or galvanized fasteners that was tested.

In order to prevent or minimize corrosion of metal fasteners, such as nails and screws in the wood, boric acid can be added in the range of from about 0.25 to 10 percent of the weight of the solution and preferably from about 0.5 to 5 percent by weight. The enhanced corrosion inhibition characteristics of the boric acid are illustrated in the examples. Monoethanol amine may be used to solublize boric acid, preferably at a ratio to the boric acid of 5:1.

Other adjuvants may be included in the composition as known to one of ordinary skill in the art. Other water soluble biocides, fungicides and insecticides may be included in the composition. Any organic insecticide or fungicide that can be solubilized by an aqueous amine oxide solution is suitable for use in the present composition. Suitable insecticides include, but are not limited to, chloropyrifos, folpet, captafol, captan, pyrethroids, and any combination of any of the foregoing. Water soluble inorganic copper compounds, other types of quaternary ammonium compounds, and combinations thereof may be added to the solution.

Another embodiment of the present invention is a method for preserving and/or waterproofing a wood substrate by contacting a wood substrate with the composition of the present invention. The composition may be applied by any wood treating method known to one of ordinary skill in the art including, but not limited to, brushing, dipping, soaking, vacuum impregnation (e.g. double vacuum technique), and pressure treatment using various cycles. Pressure treatment is a preferred method of application of the composition of this invention.

A number of compositions were prepared according to the process referred to above. These compositions were found to be stable at a dilution of from about 1 to 20 percent with water. The following compositions were prepared according to this invention and found to be stable at use dilutions of from about 1 percent to 20 percent with water:

| COMPOUND | A | B | C | D | E |
|---|---|---|---|---|---|
| COPPER SULFATE | 0.00 | 9.50 | 9.50 | 0.00 | 0.00 |
| BORIC ACID | 25.00 | 0.00 | 5.50 | 1.00 | 10.0 |
| ALKYL DIMETHYL | 6.00 | 0.00 | 0.00 | 0.00 | 0.00 |
| BENZYL AMMONIUM | | | | | |
| CHLORIDE (50%) | | | | | |
| ALKYL DIMETHYL | 6.00 | 4.50 | 4.50 | 1.00 | 10.00 |
| BENZYL AMMONIUM | | | | | |
| SACCHARINATE (98%) | | | | | |
| MONOETHANOLAMINE | 10.00 | 9.50 | 25.00 | 2.50 | 5.00 |
| ETHANOL | 15.00 | 10.00 | 10.00 | 50.0 | 20.00 |
| PROPYLENE GLYCOL | 38.00 | 9.00 | 9.00 | 0.00 | 20.00 |
| MYRISTAMINE OXIDE | 0.00 | 7.50 | 7.50 | 1.00 | 10.00 |
| WATER | 0.00 | 50.00 | 29.0 | 44.50 | 25.00 |

While this preservation solution can be applied by brushing or dipping, pressure treating is preferred.

The wood can be treated by simple pressure treating with the solution. In order to get penetration in the wood it is preferred that a vacuum be used to remove air from the wood cells which can then be flooded with the solution under pressure. A vacuum of from 15 to 30 inches of HG to remove air from the wood cells can be used. Preferably 20 to 25 inches of HG is needed. The wood can then be pressure treated with the treatment solution at a pressure from 50 to 200 PSI and preferably at a temperature above 150° F. Preferably a positive pressure of 150 PSI and a temperature of approximately 150° F. is needed for a period of one hour.

It has been found that the above treatment does produce a completely penetrated pressure treated wood. This method is capable of achieving the American Wood-Preservers' Association standard of 0.4 lbs. per cubic foot of preservative. This is necessary to prevent fungal or insect attacks of the wood. Once the wood has been washed after treatment and dried, the water and ethanol are easily evaporated leaving the insoluble alkyl dimethyl benzyl ammonium saccharinate in the wood. Heating the wood after washing with water following the pressure treatment tends to fix the alkyl dimethyl benzyl ammonium saccharinate to the wood. Wood samples have been prepared as shown in the following examples and weighed to determine the amount of the saccharinate in the wood by the weight gain after treatment.

Ethanol is especially useful in the system because of its high evaporation rate in the wood.

The preservation solution of this invention can be used on all types of wood. It protects the wood from attack by pests such as insects, fungus and mold.

Wood can be treated with the composition of this invention in the usual manner (e.g. by soaking impregnating, etc.). The composition impregnates wood relatively easily and following impregnation is highly leach-resistant. The composition of this invention demonstrates an affinity for wood and is preferentially absorbed.

The present invention provides an arsenic-free composition for wood preservation. This composition has a low mammalian toxicity, but has very effective biocidal properties.

Other systems, methods, features, and advantages of the present invention will be or become apparent to one with skill in the art upon examination of the following detailed description. It is intended that all such additional systems, methods, features, and advantages included within this description, be within the scope of the present invention, and be protected by the accompanying claims.

### EXAMPLE 1

In this example wood was pressure treated using an alkyl dimethyl benzyl ammonium saccharinate (ADBAS) and an alkyl dimethyl benzyl ammonium chloride (ADBAC). A water based system was used for pressure treating wood with both of these preservatives. Since the ADBAS compound is extremely water insoluble, it was necessary to find a method for making it soluble in water for the pressure treating. It was found that the ADBAS compound was water soluble when mixed with approximately equal volumes of ethanol and water in an amount of about 5 percent or less of the weight of the ADBAS of the solution at a temperature of approximately 150° F.

In this process a laboratory treatment device that simulates a typical treatment process for lumber that is used in the industry today was used. The steps in this procedure were as follows:
1. To remove moisture a wood test sample measuring 4.75″×0.75″×1.50″ with a volume of 0.0029 cubic feet was dried in an oven for 24 to 36 hrs.
2. The wood test sample was weighed and placed in vacuum chamber. The vacuum chamber was sealed.
3. The vacuum pump was turned on and a vacuum of 20″ to 25″ of Hg was applied for 60 minutes.
4. At the end of the vacuum cycle the vacuum pump was turned off and vacuum inlet was closed.
5. The treatment solution inlet was opened allowing the vacuum to pull the treatment solution into the vacuum chamber. The treatment solution inlet was closed.
6. The pressure inlet was opened and a pressure of 135 to 150 psi was applied.
7. The temperature was increased to 150 degrees F. The vacuum and temperature was held for a period of 60 minutes.
8. After 60 minutes the heating was discontinued and the pressure was held for another 60 minutes while the solution cooled.
9. After the cooling period, the vacuum chamber was opened and the wood test samples were removed, washed and allowed to air cool for 2 to 3 hours.
10. The wood test samples were then placed in an oven at 160 degrees F. for 48 hrs.
11. After the drying period the wood test samples were removed from the oven, allowed to cool to room temperature and weighed to determine the weight of treatment solution absorbed by the wood test samples.

This test procedure was employed with a wood test sample of white wood prepared as indicated above. Table I below shows the composition of the treatment solutions used in this experiment.

TABLE I

| COMPOUND | SAMPLE #50 | SAMPLE #51 |
|---|---|---|
| ALKYL DIMETHYL BENZYL | 150 GRAMS | NONE |
| AMMONIUM | | |
| SACCHARINATE (100%) | | |
| ALKYL DIMETHYL BENZYL | NONE | 300 GRAMS |
| AMMONIUM CHLORIDE | | |
| (50%) | | |
| ETHANOL (99%) | 1425 GRAMS | 1350 GRAMS |
| WATER | 1425 GRAMS | 1350 GRAMS |

TABLE II

| | | | WEIGHT |
|---|---|---|---|
| | INITIAL WEIGHT | FINAL WEIGHT | GAIN |
| SAMPLE # | (GRAMS) | (GRAMS) | (GRAMS) |
| 50-1 (ADBAC) | 48.282 | 51.300 | 3.018 |
| 50-2 (ADBAC) | 50.278 | 53.700 | 3.422 |
| 50-3 (ADBAC) | 48.982 | 51.800 | 2.818 |
| AVERAGE | | | 3.086 |
| WEIGHT GAIN | | | |
| 51-1 (ADBAC) | 45.475 | 48.035 | 2.560 |
| 51-2 (ADBAC) | 45.619 | 47.475 | 1.856 |
| 51-3 (ADBAC) | 48.517 | 50.817 | 2.300 |
| AVERAGE | | | 2.239 |
| WEIGHT GAIN | | | |

In order to use the alkyl dimethyl benzyl ammonium saccharinate, it was necessary to mix it with ethanol and then mix it with water. The ADBAC was mixed with a mixture of ethanol and water. Equal amounts of ethanol and water were used with approximately 5 percent by weight of the alkyl dimethyl benzyl ammonium saccharinate added to the solution of ethanol and water.

The American Wood-Preservers' Association (AWPA) requires a standard of 0.4 pounds of an alkaline quaternary preservative per cubic foot of wood. In this particular example each wood sample would have to absorb 0.53 grams of the test solution. Table II illustrates the weight gain of each sample. All of the samples had a weight gain in excess of 1.8 grams, which was far in excess of the AWPA standard. The concentration of the treatment solution can be reduced in commercialization. Several of the wood samples were cut in half to examine the penetration of the preservative. It was found that there was 100 percent penetration of the all wood test samples cut in half.

### EXAMPLE 2

In this example, the extent to which the alkyl dimethyl benzyl ammonium chloride compound and the alkyl dimethyl benzyl ammonium saccharinate leach from the wood into water is measured. Wood test blocks prepared in accordance with Example 1, were subjected to a leaching study.

In this leaching study the following procedure was observed.
1. The wood test block was placed in 500 ml plastic containers with screw caps.
2. Water was added to the container to over flowing and the container was sealed.
3. The containers were stored at room temperature.
4. After two days the containers were opened and the leachate was analyzed for an active quaternary compound using a Hach DR/2400 Spectrophotometer.

The results of this study are set forth below in Table III.

TABLE III
Results

| | START DATE | FINAL DATE |
|---|---|---|
| TEST SAMPLE | May 6, 2004 | May 8, 2004 |
| 50-1 (ADBAS) | 0.00 | 14.17 PPM QAC |
| 50-2 (ADBAS) | 0.00 | 14.08 PPM QAC |
| 50-3 (ADBAS) | 0.00 | 13.45 PPM QAC |
| AVERAGE | | 13.90 PPM QAC |
| 51-1 (ADBAC) | 0.00 | 32.00 PPM QAC |
| 51-2 (ADBAC) | 0.00 | 57.52 PPM QAC |
| 51-3 (ADBAC) | 0.00 | 46.20 PPM QAC |
| AVERAGE | | 45.24 PPM QAC |

The results set forth in Table III, indicate that sample numbers 50.1, 50.2 and 50.3 which contain the ADBAS compound had an average of 13.9 parts per million (PPM) of a quaternary ammonium compound leaching into the water. The samples 51.1, 51.2, and 51.3 containing the ADBAC compound had an average of 45.24 PPM of the quaternary ammonium compound leaching into the water. Based on the results of this test, the ADBAC compound leached 3.25 times as much of the quaternary ammonium compound as the ADBAS compound. It is important that there be as little leaching as possible so the preservative compound remains in the wood to provide biological protection and also to prevent leached material from damaging the environment, as the material can be very damaging.

### EXAMPLE 3

It has been widely reported in the literature that the new alkaline copper quaternary compound (ACQ) created a serious problem in respect to pressure treated lumber. The ACQ resulted in severe corrosion for galvanized and steel nails commonly used as fasteners for the construction process using the treated lumber. This experiment was designed to evaluate the comparative corrosive characteristics of the alkyl dimethyl benzyl ammonium chloride (ADBAC) versus the alkyl dimethyl benzyl ammonium saccharinate (ADBAS). The following procedure was used to determine the relative corrosion effect of the ADBAC and of the ADBAS. The following procedure was used in conducting this test.
1. The samples were prepared by blending compounds until uniform and clear. The ethanol and the myristamine oxide were mixed and heated from 100 to 130° F., the ADBAS or ADBAC were slowly added to the mixture along with the other compounds and mixed until the compounds were completely dissolved.
2. Test solutions were placed into plastic screw top containers.
3. Number 12D hot galvanized common and 12D bright common (steel)
4. Test containers were sealed and stored at room temperature.
5. At periodic times samples were observed for changes in appearance.

The composition of the preservative is set forth in Table IV.

TABLE IV

| COMPOUND | 58A | 58B | 58C | 58D |
|---|---|---|---|---|
| COPPER SULFATE | 0.95% | 0.95% | 0.95% | 0.95% |
| BORIC ACID | 0.55% | 0.55% | — | 0.55% |
| ALKYL DIMETHYL | 0.45% | — | 0.45% | — |
| BENZYL | | | | |
| AMMONIUM | | | | |
| SACCHARINATE | | | | |
| (100%) | | | | |
| ALKYL DIMETHYL | — | 0.45% | — | — |
| BENZYL | | | | |
| AMMONIUM | | | | |
| CHLORIDE (100%) | | | | |
| MONOETHANOLA | 2.50% | 2.50% | 2.50% | 2.50% |
| MINE 99% | | | | |
| ETHANOL | 1.00% | 1.00% | 1.00% | 1.00% |
| PROPYLENE | 0.90% | 0.90% | 0.90% | 0.90% |
| GLYCOL | | | | |
| MYRISTAMINE | 0.75% | 0.75% | 0.75% | 0.75% |
| OXIDE | | | | |
| WATER | 92.9% | 92.9% | 93.45% | 93.35% |

A scale from one to ten was used to evaluate the corrosive effect of the test solution on test nails, with one representing a slight corrosion and ten being extreme corrosion. The testing was started on May 11, 2004 and ended on Aug. 24, 2004. The results of the test are set forth in Table V.

TABLE V

| | May 11, 2004 | | Jul. 12, 2004 | | Jul. 26, 2004 | | Aug. 24, 2004 | |
|---|---|---|---|---|---|---|---|---|
| SAMPLE # | GAV | STEEL | GAV | STEEL | GAV | STEEL | GAV | STEEL |
| 58A | | | 2 | 1 | 3 | 1 | 3 | 1 |
| 58B | | | 4 | 1 | 8 | 2 | 8 | 4 |
| 58C | | | 10 | 10 | 10 | 10 | 10 | 10 |
| 58D | | | 8 | 1 | 8 | 1 | 8 | 1 |

The results of the test clearly indicate that the ADBAS and boric acid sample 58A was much less corrosive towards both galvanized and steel nails than the compound ADBAC and boric acid (58B). It is interesting that sample 58C showed the heaviest amount of corrosion for both galvanized and steel nails. Sample 58C only included the ADBAS compound and no boric acid. A comparison of samples 58A, 58B, and 58C discloses that the addition of boric acid to the ADBAS compound offered the greatest amount of corrosion inhibition. This clearly shows that there is a synergistic effect in the combination of the boric acid and the ADBAS compound. Sample 58D was used as a control and contained no quaternary ammonium compound but did contain boric acid.

The nails used were weight tested and the results set forth in Table VI below. Sample 58A containing the ADBAS compound with boric acid and 58B containing the ADBAC compound with boric acid were weighed and the weight loss compared. In respect to both galvanized and steel nails, Table VI clearly shows there was less weight loss with the ADBAS compound than with the ADBAC compound. The galvanized nails exposed to the ADBAS solution lost an average weight of 0.082 grams. The galvanized nails exposed to the ADBAC compound lost an average weight of 0.188 grams or 23 times more weight. The steel nails exposed to the ADBAS compound lost an average weight of 0.002 grams while the steel nails exposed to the ADBAC compound lost an average weight of 0.017 grams or 8.5 times more weight. This clearly shows that the ADBAS and boric acid mixture is much less corrosive to metal nails and other types of metal fasteners than the ADBAC compound and boric acid. These results were fully supported by visual inspection of the nails.

TABLE VI

| | INITIAL WT. | FINAL WT | WEIGHT |
|---|---|---|---|
| SAMPLE # | May 11, 2004 | Aug. 24, 2004 | LOSS |
| 58A | 10.399 | 10.301 | 0.098 |
| GALVANIZED | | | |
| 58A | 10.321 | 10.250 | 0.071 |
| GALVANIZED | | | |
| 58A | 11.655 | 11.577 | 0.078 |
| GALVANIZED | | | |
| AVERAGE WT | | | 0.082 |
| LOSS | | | |
| 58A STEEL | 6.721 | 6.727 | 0.00 |
| 58A STEEL | 6.775 | 6.769 | 0.006 |
| 58A STEEL | 6.775 | 6.769 | 0.006 |
| AVERAGE WT | | | 0.002 |
| LOSS | | | |
| 58B | 10.391 | 10.223 | 0.168 |
| GALVANZIED | | | |
| 58B | 10.000 | 9.829 | 0.171 |
| GALVANZIED | | | |
| 58B | 9.958 | 9.732 | 0.226 |
| GALVANIZED | | | |
| AVERAGE WT | | | 0.188 |
| LOSS | | | |
| 58B STEEL | 6.703 | 6.688 | 0.015 |
| 58B STEEL | 6.748 | 6.734 | 0.014 |
| 58B STEEL | 6.679 | 6.657 | 0.022 |
| AVERAGE WT | | | 0.017 |
| LOSS | | | |

### EXAMPLE 4

In this example test blocks were prepared in accordance with the procedure of Example 1 and subjected a leaching study using the following procedure.
1. The wood test blocks were placed in 500 ml plastic containers with screw caps.
2. Water was added to the containers to over flowing and the container was sealed.
3. The containers were stored at room temperature.

4. After two days the containers were opened and the leachate was analyzed for active quaternary compound (QAC) using a Hach DR/2400 Spectrophotometer.

TABLE VII

| | START DATE | FINAL DATE |
|---|---|---|
| TEST SAMPLE | Sep. 1, 2004 | Sep. 5, 2004 |
| 50-5 (ADBAS) | 0.00 | 80.00 PPM QAC |
| 50-4 (ADBAS) | 0.00 | 46.00 PPM QAC |
| 50-6 (ADBAS) | 0.00 | 52.00 PPM QAC |
| AVERAGE | | 59.33 PPM QAC |
| 51-4 (ADBAC) | 0.00 | 500.0 PPM QAC |
| 51-5 (ADBAC) | 0.00 | 470.0 PPM QAC |
| 51-6 (ADBAC) | 0.00 | 470.0 PPM QAC |
| AVERAGE | | 480.0 PPM QAC |

Test samples 50.4, 50.5, and 50.6 were treated with ADBAS while samples 51.4, 51.5, and 51.6 were treated with ADBAC compounds.

Samples 50-4, 50-5, and 50-6 treated with ADBAS had an average of 59.33 PPM quaternary ammonium compound (QAC) leaching into the water over the test period. Samples 51-4, 51-5, and 51-6 containing the ADBAC compound had an average of 480.0 PPM quaternary ammonium compound leaching into the water under identical circumstances. The ADBAC compound leached 8.1 times as much as the ADBAS compound.

Therefore, having thus described the invention, at least the following is claimed:

1. A wood preservative for the protection of wood against microorganisms and insects or waterproofing wood, which comprises a solution of water and an alkyl dimethyl benzyl ammonium saccharinate which is present in an amount of from 1 to 10 percent by weight of the solution, and an alcohol with less than six carbon atoms which is present in an amount of from 30 to 70 percent by weight of the solution and water in amount of from 30 to 70 percent by weight of the solution.

2. The wood preservative of claim 1, in which the alkyl group of the alkyl dimethyl benzyl ammonium saccharinate has from 10 to 16 carbon atoms.

3. The wood preservative of claim 1, in which the alkyl dimethyl benzyl ammonium saccharinate is a mixture of said saccharinates in which approximately 50 percent of the saccharinates have alkyl groups with 14 carbon atoms, approximately 40 percent of the saccharinates have alkyl groups with 12 carbon atoms and approximately 10 percent of the saccharinates have alkyl groups with 16 carbon atoms.

4. The wood preservative of claim 1, in which the alcohol is a mixture of water miscible alcohols.

5. The wood preservative of claim 1, in which the alcohol is ethanol.

6. A wood preservative for the protection of wood against microorganisms and insects, which comprises a solution of water and an alkyl dimethyl benzyl ammonium saccharinate which is present in an amount of from 1 to 10 percent by weight of the solution, and ethanol which is present in an amount of from 30 to 70 percent by weight of the solution and water in an amount of from 30 to 70 percent by weight of the solution.

7. The wood preservative of claim 1, in which the alkyl dimethyl benzyl ammonium saccharanite is present in an amount of from 2 to 6 percent by weight of the solution, and the alcohol is present in an amount of from 40 to 60 percent by weight of the solution.

8. The wood preservative of claim 6, in which the alkyl dimethyl benzyl ammonium saccharanite is present in an amount of from 2 to 6 percent by weight of the solution, and ethanol is present in an amount of from 40 to 60 percent by weight of the solution.

9. A method of treating wood to preserve it from attacks by microorganisms and insects which comprises pressure treating the wood with a solution of water and an alkyl dimethyl benzyl ammonium saccharinate which is present in an amount of from 2 to 10 percent by weight of the solution, and an alcohol with less than six carbon atoms which is present in an amount of from 30 to 70 percent by weight of the solution and water in amount of from 30 to 70 percent by weight of the solution.

10. The method of claim 9, in which the wood is first subjected to a partial vacuum and immediately thereafter pressure treated.

11. A method of preserving the wood substrate, the method comprising contacting the wood substrate with a preservative effective amount of the wood preservative of claim 1.

12. A method for waterproofing a wood substrate, the method comprising contacting the wood substrate with a waterproofing effective amount of the composition of claim 1.

13. An article comprising:
a wood substrate; and
b a biocidally effective amount of a composition as defined in claim 1.

14. A composition comprising:
a. a preservative amount of an alkyl dimethyl benzyl ammonium saccharinate;
b. a solvent selected from the group consisting of an alcohol with less than six carbon atoms and a water soluble amine oxide; and
c. water,
wherein the composition is substantially free of chlorides.

15. A solution comprising:
a. an alkyl dimethyl benzyl ammonium saccharinate in an amount of from 1 to 10 percent by weight of the solution;
b. a water soluble amine oxide in an amount as a percentage of the alkyl dimethyl benzyl ammonium saccharinate of from 25 to 500 percent by weight of the saccharinate; and
c. water.

16. The solution of claim 15, in which the water soluble oxide is selected from the group consisting of myristamine oxide and lauramine oxide.

17. A solution comprising:
a. an alkyl dimethyl benzyl ammonium saccharinate in an amount of from 1 to 10 percent by weight of the solution;
b. a solvent for the alkyl dimethyl benzyl ammonium saccharinate selected from the group consisting of myristamine oxide and lauramine oxide which is present in an amount as a percentage of the alkyl dimethyl benzyl ammonium saccharinate of from 25 to 500 percent by weight of the saccharinate; and
c. water.

18. The solution of claim 17, in which boric acid is also present in an amount of from 0.25 to 5 percent by weight of the solution.

19. The solution of claim 17, in which an alcohol with less than six carbon atoms is present in a ratio of 1 to 5 to the saccharinate by weight.

20. A solution comprising:
a. an alkyl dimethyl benzyl ammonium saccharinate in an amount of from 1 to 10 percent by weight of the solution;
b. a solvent for the alkyl dimethyl benzyl ammonium saccharinate selected from the group consisting of myristamine oxide and lauramine oxide which is present in an amount as a percentage of the alkyl dimethyl benzyl ammonium saccharinate of from 25 to 500 percent by weight of the saccharinate; and
c. a compound selected from the group consisting of an alcohol with less than six carbon atoms and an alkylene glycol with from 2 to 4 carbon atoms and mixtures thereof which is present in a ratio of 1 to 5 to the saccharinate by weight; and
d. water.

21. A solution comprising:
a. an alkyl dimethyl benzyl ammonium saccharinate in an amount of from 1 to 10 percent by weight of the solution;
b. a solvent for the alkyl dimethyl benzyl ammonium saccharinate selected from the group consisting of myristamine oxide and lauramine oxide which is present in an amount as a percentage of the alkyl dimethyl benzyl ammonium saccharinate of from 25 to 500 percent by weight of the saccharinate; and
c. a compound selected from the group consisting of an alcohol with less than six carbon atoms and an alkylene glycol with from 2 to 4 carbon atoms and mixtures thereof which is present in a ratio to 1 to 5 to the saccharinate by weight; and
d. water.

22. The solution of claim 21, in which boric acid is also present in an amount of from 0.25 to 5 percent by weight of the solution.

23. The solution of claim 21, in which the alcohol is ethanol and the glycol is propylene glycol and both are present in a substantial amount.

24. A method for preserving a wood substrate, the method comprising contacting the wood substrate with a biocidally effective and preservative enhancing amount of the solution of claim 23.

25. A method for waterproofing a wood substrate, the method comprising contacting the wood substrate with a waterproofing effective amount of the solution of claim 23.

26. An article comprising:
a wood substrate; and
b a biocidally effective amount of the solution as defined in claim 23.

27. The method of claim 24, in which the wood is first subjected to a partial vacuum and immediately thereafter pressure treated.

28. The method of claim 27, in which heat is applied to the wood during pressure treating at a temperature and for a time to insure the penetration of the solution into the wood and the retention in the wood of preservation compounds in the solution.

29. The wood preservative of claim 8, in which boric acid is also present in an amount of from 0.25 to 5 percent of the weight of the solution.

30. A method of preparing an aqueous solution containing from 1 to 10 percent by weight of the solution of an alkyl dimethyl benzyl ammonium saccharinate which comprises first mixing said saccharinate with from a solution of ethanol and mixing the solution of said saccharinate and ethanol with water in an amount of so that from 30 to 70 percent by weight of the aqueous solution is ethanol.
